(19) United States
(12) Patent Application Publication
(10) Pub. No.: US 2017/0341640 A1
(43) Pub. Date: Nov. 30, 2017

(54) INTELLIGENT PARKING SYSTEM

(71) Applicant: HON HAI PRECISION INDUSTRY CO., LTD., New Taipei (TW)

(72) Inventor: TIEN-PING LIU, New Taipei (TW)

(21) Appl. No.: 15/390,740

(22) Filed: Dec. 27, 2016

(30) Foreign Application Priority Data
May 27, 2016 (TW) 105116713

(51) Int. Cl. B60W 30/06; G08G 1/14

(52) U.S. Cl. CPC B60W 30/06; G08G 1/144

(57) ABSTRACT

An intelligent parking system includes a first three-dimensional detecting module configured to obtain size information of a vehicle, a second three-dimensional detecting module configured to obtain space information of the parking lot, a spatial calculation module configured to obtain parking space requirement information, a parking space displaying module configured to adjust and display a coordinate position and a size of the parking space, a path planning module configured to obtain navigation planning path information, a vehicle guiding module configured to guide the vehicle, and a space warning module configured to judge whether the vehicle enters the corresponding parking space.

### CROSS-REFERENCE TO RELATED APPLICATIONS

This application claims all benefits accruing under 35 U.S.C. §119 from Taiwan Patent Application No. 105116713, filed on May 27, 2016, in the Taiwan Intellectual Property Office, the disclosure of which is incorporated herein by reference.

### FIELD

The present application relates to an intelligent parking system.

### BACKGROUND

With the development of modern society, people's living standards continue to be improved, and the number of motor vehicles is increasing. And accordingly, vehicle parking has gradually attracted people's attention.

For the existing parking lot, to park various vehicles having different volumes, the parking lot is generally designed to have a lot of parking spaces with the same size, and the parking spaces are designed according to the larger volume vehicle. When more medium and small volume vehicles are parked in the parking lot with larger parking spaces, which will cause a waste of space.

What is needed, therefore, is to provide an intelligent parking system that can overcome the above-described shortcomings.

### BRIEF DESCRIPTION OF THE DRAWINGS

Implementations of the present technology will now be described, by way of example only, with reference to the attached figures, wherein:

FIG. 1 is a schematic view of one embodiment of an intelligent parking system.

FIG. 2 is a schematic view of one embodiment of parallel LED line markings.

FIG. 3 is a schematic view of one embodiment of parallel and vertical LED line markings.

FIG. 4 is a schematic view of one embodiment of an intelligent parking method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale, and the proportions of certain parts may be exaggerated to illustrate details and features better. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

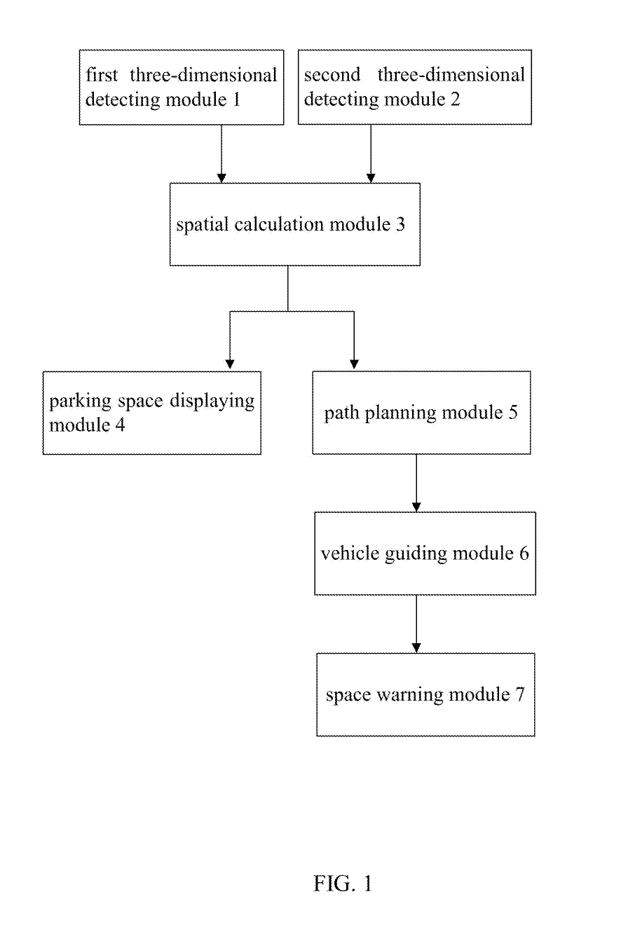

Referring to FIG. 1, an embodiment of an intelligent parking system includes a first three-dimensional detecting module 1, a second three-dimensional detecting module 2, a spatial calculation module 3, a parking space displaying module 4, a path planning module 5, a vehicle guiding module 6, and a space warning module 7.

The first three-dimensional detecting module 1 is used to detect the length, width, and height of the vehicle when the vehicle enters the parking lot, to obtain size information of the vehicle; and send size information to the spatial calculation module 3. The size information includes length information, width information, and height information of the vehicle. The first three-dimensional detecting module 1 can be a device used to detect the size of the vehicle by laser or radar, such as laser and radar sensor (LiDAR), range camera (RGB-D camera). The first three-dimensional detecting module 1 can be located at the entrance of the parking lot. When the vehicle enters the parking lot, the three-dimensional detecting module 1 can detect the size information of the vehicle immediately.

The second three-dimensional detecting module 2 is used to scan and monitor whole parking lot to obtain space information of the parking lot, and send the space information to the spatial calculation module 3. The second three-dimensional detecting module 2 can be a device used to scan and monitor whole parking lot by laser or radar, such as laser and radar sensor (LiDAR), range camera (RGB-D camera). The second three-dimensional detecting module 2 can be located at multiple positions of the parking lot, to scan and monitor the parking lot. The space information of the parking lot includes whole space information, occupied parking space information, and not occupied parking space information. The first three-dimensional detecting module 1 and the second three-dimensional detecting module 2 have the same working principle.

The spatial calculation module 3 is used to receive the size information from the first three-dimensional detecting module 1 and the space information from the second three-dimensional detecting module 2; analyze the size information and the space information to obtain parking space requirement information; and send the parking space requirement information to the parking space displaying module 4 and the path planning module 5. The spatial calculation module 3 can distribute appropriate parking space to the vehicle. The appropriate parking space can accommodate appropriate vehicle, which can avoid the vehicle being collided.

The parking space displaying module 4 is used to receive the parking space requirement information from the spatial calculation module 3. In order to accommodate appropriate vehicle, the parking space displaying module 4 can also adjust and display the coordinate position and size of the parking space. The parking space displaying module 4 includes many line markings formed by light from a light source. The light source can be selected according to need, and the light source can comprises a light emitting diode (LED), laser, or fluorescent. That is, the line markings can be LED line markings, laser line markings, or fluorescent line markings. In one embodiment, the line markings are LED line markings. The LED line marking is a straight line formed by the light emitting diode (LED). The LED line marking can be embedded in the ground of the parking lot. The LED can also be set on top of the parking lot, and the light beam from LED vertically irradiates on the ground of the parking lot to form the LED line marking. The many LED line markings can be parallel to each other, perpendicular to each other, or cross to each other. The distance between two adjacent LED line markings is equal to each other. After receiving the parking space requirement information, the LED line markings of the corresponding coordinate position will be bright automatically. The bright LED line markings will enclose a parking space to wait for the vehicle to enter. The bright LED line markings will be dark after the vehicle enters the parking space.

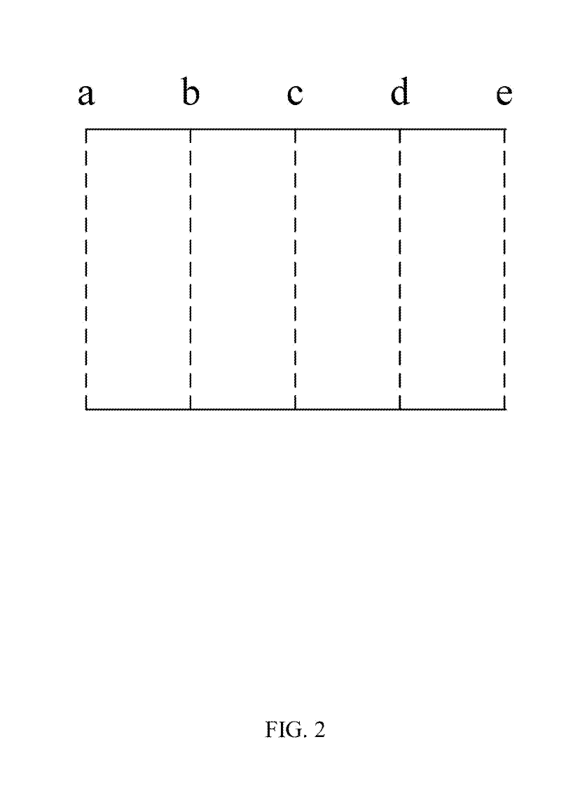

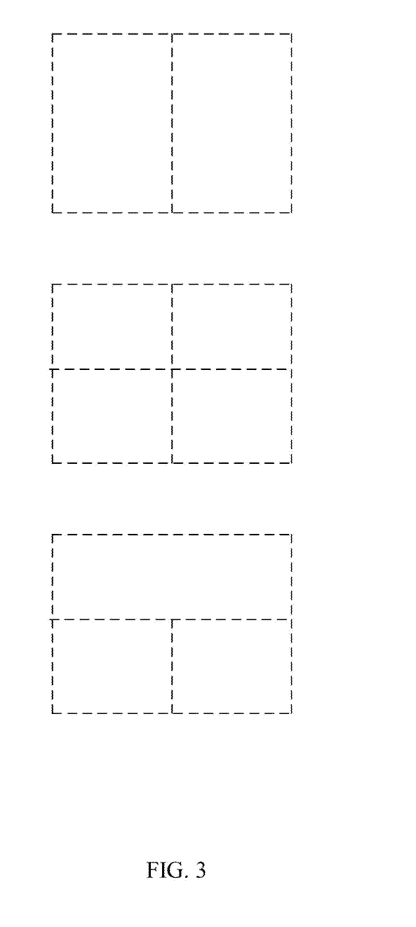

The parking space can be adjusted according to the size of the vehicle, which can be achieved by selecting the LED line markings located at different positions. Seen from FIG. 2, when smaller vehicle enters the parking lot, the LED line markings a and c will be selected and bright, and the bright LED line markings a and c enclose a parking space to hold the smaller vehicle; when larger vehicle enters the parking lot, the LED line markings a and d will be selected and bright. Seen from FIG. 3, in the same parking area, the parking space can be divided into various small parking spaces according to different volumes of the vehicles.

The path planning module 5 is used to receive the parking space requirement information from the spatial calculation module 3, analyze the parking space requirement information to obtain navigation planning path information and send the navigation planning path information to the vehicle guiding module 6.

The vehicle guiding module 6 is used to receive the navigation planning path information from the path planning module 5, and guide the vehicle to enter corresponding parking space. The guiding mode from the vehicle guiding module 6 can be selected from the group consisting of voice guiding, image guiding, LED indicator guiding, global positioning system (GPS), and wireless fidelity (WIFI). The vehicle guiding module 6 can send voice guiding or video guiding to the terminal receiving device of the vehicle or phone of the driver, and the vehicle can enter the parking space according to the video guiding or video guiding. Many LED indicators can be located in the parking lot, when the LED indicators receive the navigation planning path information, corresponding LED indicators are bright, and the vehicle can enter the parking space according to the LED indicators guiding.

The vehicle guiding module 6 further includes a vehicle transfer device. When the vehicle transfer device receives the navigation planning path information, the vehicle transfer device moves to the vehicle that is coming, and guide this vehicle to enter corresponding parking space. In one embodiment, when the vehicle transfer device receives the navigation planning path information, the vehicle transfer device moves to one side of the vehicle that is coming and guide this vehicle to enter corresponding parking space according to some guiding mode, such as, voice guiding. The vehicle transfer device can also be used to load the vehicle, and deliver the vehicle to corresponding parking space.

The space warning module 7 is used to send parking correction information to the spatial calculation module 3 after the vehicle enters corresponding parking space. When the vehicle does not enter corresponding parking space completely, or the vehicle is not traveling or parking according to the guiding, the space warning module 7 will issue a warning.

The space warning module 7 monitors the vehicle according to the parking space requirement information from the spatial calculation module 3 and the navigation planning path information from the path planning module 5. When the vehicle enters corresponding parking space under the guiding, the space warning module 7 will judge whether the vehicle enters corresponding parking space completely, and send parking correction information to the spatial calculation module 3. When the vehicle does not completely enter corresponding parking space that is marked by the line markings, the space warning module 7 will issue the warning until the vehicle enters corresponding parking space accurately. When the vehicle is not traveling or parking according to a specific route, the space warning module 7 will issue the warning. In the process of traveling or parking, the space warning module 7 can timely issue the warning. It can avoid that the vehicle enters an area which cannot accommodate the vehicle. It can also avoid that many vehicles simultaneously travel in the parking lot, and accordingly, the problem of congestion in the parking lot will be resolved. When all of the parking spaces are occupied, the space warning module 7 will issue warnings to the vehicles located at the entrance of the parking lot, and prevent those vehicles from entering the parking lot.

The intelligent parking system can automatically detect the size of the vehicle and the space of the parking lot by three-dimensional detecting module, and can flexibly plan the required navigation path and allocate a specific parking space for each vehicle. Thus the vehicle can safely reach the parking spaces. Furthermore, the parking space can be reasonably planned, enough to accommodate the vehicle itself and at the same time not to cause the waste of the parking space. Also, there is no need to plot fixed line markings in the parking area. The parking space displaying module 4 can automatically change the line markings according to the size of vehicles. It is not only suitable for various types of vehicle to park, but also improve the parking space utilization. The intelligent parking system has broad application prospects.

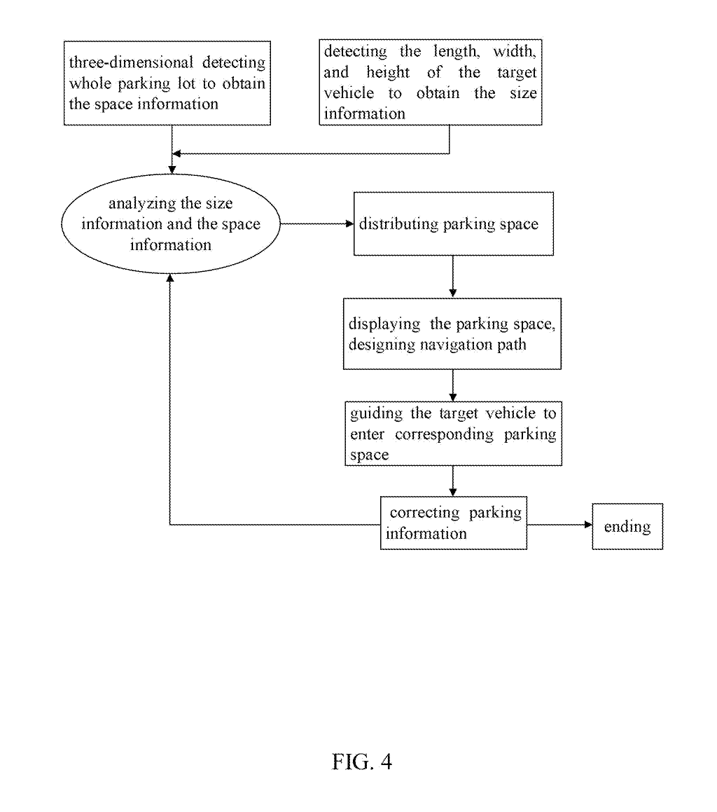

Referring to FIG. 4, an intelligent parking method of the intelligent parking system includes following steps:

S1, detecting the length, width, and height of the target vehicle by the first three-dimensional detecting module 1 to obtain the size information of the target vehicle, and three-dimensional detecting whole parking lot by the second three-dimensional detecting module 2 to obtain the space information;

S2, analyzing the size information and the space information by the spatial calculation module 3 to obtain parking space requirement information, and sending the parking space requirement information to the parking space displaying module 4 and the path planning module 5 by the spatial calculation module 3;

S3, adjusting and displaying the coordinate position and size of the parking space by the parking space displaying module 4 according to the parking space requirement information, analyzing the parking space requirement information by the path planning module 5 to obtain the navigation planning path information, and sending the navigation planning path information to the vehicle guiding module 6 by the path planning module 5;

S4, guiding the target vehicle by the vehicle guiding module 6 to enter corresponding parking space;

S5, judging whether the target vehicle enters corresponding parking space by the space warning module 7, and sending the parking correction information to the spatial calculation module 3 by the space warning module 7.

In the step S1, the target vehicle is a vehicle that enters the parking lot and needs a parking space. The first three-dimensional detecting module 1 and the second three-dimensional detecting module 2 are located at the entrance of the parking lot and the interior of the parking space. Thus, the target vehicle and the parking lot are simultaneously measured. The acquired vehicle size information and the parking space information are sent to the spatial calculation module 3. The measurement to the parking lot includes not only collecting the parking space information, but also considering many factors, such as the ground height of the parking lot, and the cable distribution. An all-dimensional spatial map of the parking lot can be provided to the spatial calculation module 3.

In the step S2, after receiving the size information of the target vehicle, the spatial calculation module 3 reasonably designs which parking space in the parking lot is most suitable for the target vehicle according to the space information, to obtain the parking space requirement information.

In the step S3, the parking space displaying module 4 adjusts and displays the line markings at the parking space according to the parking space requirement information, so that the target vehicles can enter the corresponding parking space safely and accurately. In particular, the parking space displaying module 4 mainly adjusts the size of the parking spaces by selecting line markings at different positions. It can be understood that in the initial state, the parking space displaying module 4 can be displayed in accordance with the size of the standard parking space so that adjustment of the parking space is not required when the ordinary volume vehicle is driven therein.

In the step S4, the vehicle guiding module 6 guides the target vehicle to enter corresponding parking space according to the navigation planning path information. When the target vehicle does not follow the guidance of the vehicle guiding module 6 and deviates from the navigation planning path, the space warning module 7 will issue the warning to prompt the target vehicle or driver to return to the designated route, to avoid collision or congestion.

In the step S5, when the space warning module 7 sends the parking correction information to the spatial calculation module 3, the intelligent parking process of the target vehicle ends. When the subsequent vehicle reaches the parking lot, the intelligent parking process is resumed from the step S1.

The intelligent parking method can automatically detect the size of the vehicle and automatically allocates the appropriate parking spaces according to the space occupancy of each vehicle, which improve the utilization ratio of the parking area. The intelligent parking method can design reasonable navigation path and guides the vehicle enter corresponding parking space by combining the overall spatial information of the parking lot. It can make the vehicle quickly and easily drive into the parking space, reduce the workforce input, and be suitable for parking of the unmanned vehicle.

The embodiments shown and described above are only examples. Even though numerous characteristics and advantages of the present technology have been set forth in the foregoing description, together with details of the structure and function of the present disclosure, the disclosure is illustrative only, and changes may be made in detail, including in matters of shape, size, and arrangement of the parts within the principles of the present disclosure up to, and including, the full extent established by the broad general meaning of the terms used in the claims.

Additionally, it is also to be understood that the above description and the claims drawn to a method may include some indication in reference to certain steps. However, the indication used is only to be viewed for identification purposes and not as a suggestion as to an order for the steps.

What is claimed is:

1. An intelligent parking system, comprising:
a first three-dimensional detecting device configured to detect a length, a width, and a height of a vehicle to obtain size information of the vehicle;
a second three-dimensional detecting device configured to monitor a parking lot to obtain space information of the parking lot;
a spatial calculation module configured to analyze the size information and the space information to obtain parking space requirement information;
a parking space displaying module configured to adjust a size of a parking space and display borders of the parking space according to the parking space requirement information;
a path planning module configured to analyze the parking space requirement information to obtain navigation planning path information;
a vehicle guiding module configured to guide the vehicle to enter a corresponding parking space according to the navigation planning path information; and
a space warning module configured to judge whether the vehicle enters the corresponding parking space, and send parking correction information to the spatial calculation module.

2. The intelligent parking system of claim 1, wherein the first three-dimensional detecting device is located at an entrance of the parking lot.

3. The intelligent parking system of claim 1, wherein the first three-dimensional detecting device and the second three-dimensional detecting device are laser and radar sensors, or range cameras.

4. The intelligent parking system of claim 1, wherein the parking space displaying module comprises a light emitting diode, a laser, or a fluorescent, and lights from the light emitting diode, the laser, or the fluorescent form a plurality of line markings.

5. The intelligent parking system of claim 4, wherein the plurality of line markings are a plurality of LED line markings, a plurality of laser line markings, or a plurality of fluorescent line markings.

6. The intelligent parking system of claim 5, wherein the plurality of LED line markings is a straight line formed by the light emitting diode.

7. The intelligent parking system of claim 6, wherein the plurality of LED line markings is embedded in a ground of the parking lot.

8. The intelligent parking system of claim 6, wherein the plurality of LED line markings is parallel to each other, perpendicular to each other, or cross to each other.

9. The intelligent parking system of claim 8, wherein a distance between adjacent two of the plurality of LED line markings is equal to each other.

10. The intelligent parking system of claim 1, wherein a guiding mode from the vehicle guiding module is selected from the group consisting of voice guiding, image guiding, LED indicator guiding, global positioning system, and wireless fidelity.

11. The intelligent parking system of claim 1, wherein the vehicle guiding module further comprises a vehicle transfer device configured to move to and guide the vehicle when the vehicle transfer device receives the navigation planning path information.

12. The intelligent parking system of claim 11, wherein the vehicle transfer device is configured to load the vehicle, and deliver the vehicle to the corresponding parking space.

13. An intelligent parking method comprising:
S1, providing an intelligent parking system comprising a first three-dimensional detecting device, a second three-dimensional detecting device, a spatial calculation module, a parking space displaying module, a path planning module, a vehicle guiding module, and a space warning module;
S2, detecting a length, a width, and a height of a target vehicle by the first three-dimensional detecting device to obtain size information of the target vehicle, and monitoring a parking lot by the second three-dimensional detecting device to obtain space information of the parking lot;
S3, analyzing the size information of the target vehicle and the space information of the parking lot by the spatial calculation module to obtain parking space requirement information, and sending the parking space requirement information to the parking space displaying module and the path planning module by the spatial calculation module;
S4, adjusting and displaying borders of a parking space by the parking space displaying module according to the parking space requirement information, analyzing the parking space requirement information by the path planning module to obtain a navigation planning path information, and sending the navigation planning path information to the vehicle guiding module by the path planning module;
S5, guiding the target vehicle by the vehicle guiding module to enter a corresponding parking space; and
S6, judging whether the target vehicle enters the corresponding parking space by the space warning module, and sending parking correction information to the spatial calculation module by the space warning module.

14. The intelligent parking method of claim 13, wherein in the step S4, the parking space displaying module adjusts and displays the borders of the parking space by selecting a plurality of line markings at different positions.
